(19) United States
(12) Patent Application Publication
(10) Pub. No.: US 2012/0061889 A1
(43) Pub. Date: Mar. 15, 2012

(54) Hydraulic body mount

(76) Inventor: Robert J. Goudie, Grand Haven, MI (US)

(21) Appl. No.: 12/928,679

(22) Filed: Dec. 16, 2010

Related U.S. Application Data
(60) Provisional application No. 61/286,966, filed on Dec. 16, 2009.
(60) Provisional application No. 61/296,382, filed on Jan. 19, 2010.

(51) Int. Cl. F16F 9/16

(52) U.S. Cl. 267/140.11

(57) ABSTRACT

Embodiments of hydraulic mounts for vehicles are provide herein. According to some embodiments, hydraulic mounts may include an outer housing having a central axis extending therethrough, a tubular insert disposed at least partially within the outer housing and in substantial axial alignment with the central axis so as to form an annular cavity therebetween, an inner elastomeric spring and an outer elastomeric spring extending between the flange of the tubular insert and the outer housing, and a diaphragm disposed within the annular cavity.

### CROSS-REFERENCE TO RELATED APPLICATION(S)

This application claims the benefit of U.S. Provisional Application Ser. No. 61/286,966, filed Dec. 16, 2009, entitled “Short Hydraulic Body Mount With Very High Damping Using Rolling Diaphragm” and U.S. Provisional Application Ser. No. 61/296,382, filed Jan. 19, 2010, entitled “Short Hydraulic Body Mount With Very High Damping Using Rolling Diaphragm,” which are hereby incorporated herein by reference in their entirety, including all references cited therein.

### BACKGROUND OF THE INVENTION

1. Field of the Invention

The present invention relates in general to mounts and more particularly, but not by way of limitation, to hydraulic mounts having a small size and very high vertical damping, and in some embodiments to hydraulic mounts that utilize a displaceable diaphragm.

2. Background Art

Body mounts have been known in the art for years and are the subject of a plurality of applications and patents including, namely: U.S. Pat. No. 7,584,944 entitled “Hydraulically Damped Body Mount With Bolt-Through Construction;” and U.S. Pat. No. 7,637,486 entitled “Very High Damping Body Mount, Subframe Mount Or Engine Mount With Bolt-Through Construction”—all of which are hereby incorporated herein by reference in their entirety including all references cited therein.

In particular, U.S. Pat. No. 7,584,944 (hereinafter sometimes the '944 patent) appears to generally provide a low cost design that affords generally insufficient damping for most applications.

U.S. Pat. No. 7,637,486 (hereinafter sometimes the '486 patent) appears to afford very high damping, but the embodiments also appear to be constrained by the configuration of the packages on associated vehicles.

While the above-identified references appear to disclose a plurality of body mounts, their configurations take up considerable space between the body and the frame. By way of example, embodiments of the '944 patent are between 37 mm and 50 mm high. Embodiments associated with the '939 application are typically 56 mm high. Both of the above designs have approximately 12 mm of travel to function properly.

In comparison, embodiments disclosed in the present invention, are capable of being reduced down to a free height of 26 mm while still having 12 mm of available displacement. So at loaded height, the gap between the body and the frame is only nominal 22 mm. With the same available displacement as the above mounts and also the capability to produce high vertical damping, mounts constructed in accordance with the present invention open up more opportunities to apply this technology. SAE Paper 2009-01-2126 by Ping Lee describes one specific application of these high vertical damped mounts where a considerable improvement in the quality of performance is achieved.

These and other objects of the present invention will become apparent in light of the present specification, claims, and drawings.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be understood that the invention is not necessarily limited to the particular embodiments illustrated herein.

FIG. 1A of the drawings is a perspective view of a hydraulic mount constructed in accordance with the present invention;

FIG. 1B of the drawings is a cross-sectional view of the hydraulic mount of FIG. 1A taken along line A-A;

FIG. 1C of the drawings is a partial cross-sectional view showing a diaphragm of the hydraulic mount of FIGS. 1A and 1B;

FIG. 2 of the drawings is a cross-sectional view of an alternative hydraulic mount;

FIG. 3A of the drawings is a cross-sectional view of yet another hydraulic mount;

FIG. 3B of the drawings is a perspective view of one half of a tubular body for use with the hydraulic mount of FIG. 3A;

FIG. 3C of the drawings is a perspective view of an alternate tubular body for use with the hydraulic mount of FIG. 3A; and

FIG. 4 of the drawings is a cross-sectional view of yet another hydraulic mount having a tubular pathway.

### SUMMARY OF THE INVENTION

In some embodiments, the present invention is directed to a hydraulic mount that includes: (a) an outer housing having a central axis extending therethrough; (b) a tubular insert disposed at least partially within the outer housing and in substantial axial alignment with the central axis so as to form an annular cavity therebetween, the tubular insert having a flange extending from a first end of the tubular insert; (c) an inner elastomeric spring and an outer elastomeric spring extending between the flange of the tubular insert and the outer housing, the inner and the outer elastomeric springs being spaced apart from one another to define a first chamber; (d) a diaphragm disposed within the annular cavity and forming a second chamber that is in bilateral fluid communication with the first chamber, the diaphragm having a first end attached to at least a portion of the outer housing and a second end attached. to at least a portion of the tubular insert; and (e) wherein uni-axial or multi-axial displacement of at least one of the tubular insert and the outer housing relative to one another causes fluid to communicate between the first and second chambers and at least one of the first end and the second end of the diaphragm to displace relative to one another.

In other embodiments, the outer housing is adapted to operatively associate with at least a portion of a frame of a vehicle and the tubular insert is adapted to operatively associate with at least a portion of a cab of a vehicle.

In additional embodiments, the hydraulic mount further includes: one or more mounting bolts extending downwardly from a flange of the outer housing, the flange extending substantially normally to the central axis of the outer housing, the one or more mounting bolts adapted to secure the outer housing to the frame of the vehicle; and a washer disposed below the outer housing and a bolt inserted through the tubular insert for operatively connecting the at least a portion of the cab of the vehicle to the at least a portion of the frame of the vehicle.

According to other embodiments, the fluid includes a non-compressible fluid.

In alternative embodiments, the hydraulic mount further includes a path for bilateral communication of fluid between the first chamber and the second chamber, the path extending at least partially through the inner elastomeric spring.

In some embodiments, the hydraulic mount includes a helical path for the bilateral communication of fluid between the first and second chambers, the helical path extending through a casing that surrounds at least a portion of the tubular insert.

In additional embodiments, a first port of the helical path is disposed above a body of the inner elastomeric spring and a second port of the helical path is disposed below the body of the inner elastomeric spring.

In some embodiments, the present invention may be directed to a hydraulic mount that includes: (a) an outer housing having a central axis extending therethrough; (b) a tubular insert disposed at least partially within the outer housing and in substantial axial alignment with the central axis so as to form an annular cavity therebetween, the tubular insert having a first washer extending from a first end of the tubular insert; (c) a tubular body disposed within the annular cavity, the tubular body having at least one path for the bilateral communication of fluid; (d) an elastomeric core disposed between the first washer of the tubular insert and the outer housing, the elastomeric core cooperating with the outer housing and the first washer of the tubular insert to form a first chamber; (e) a diaphragm associated with the tubular body and the outer housing, the diaphragm cooperating with the tubular body to form a second chamber; and (f) wherein uni-axial or multi-axial displacement of at least one of the tubular insert and the outer housing relative to one another causes fluid to communicate between the first and second chambers via at least one path of the tubular body.

In other embodiments, the elastomeric core includes an outer portion and an inner portion spaced apart from one another by a connector that extends downwardly from the first washer of the tubular insert.

In some additional embodiments, the connector includes an outer surface associated with the outer portion of the elastomeric core and an inner surface associated with the inner portion of the elastomeric core.

In some other embodiments, the diaphragm is associated with the tubular body via a support member which is also associated with the inner portion of the elastomeric core.

According to additional embodiments, the diaphragm flares outwardly from the support member to contact a first end of the outer housing.

In some embodiments, the tubular body includes a first port associated with the first chamber and a second port associated with the second chamber.

In other embodiments, the tubular body includes a first section and a second section adapted to fit together.

In additional embodiments, the tubular body includes at least one channel extending along the outer surface of the tubular body substantially parallel to the central axis of the outer housing.

According to some embodiments, the at least one channel of the tubular body cooperates with an inner surface of the outer housing to form the at least one path for the bilateral communication of fluid.

In yet other embodiments, the outer housing is adapted to operatively associate with at least a portion of a frame of a vehicle and the tubular insert is adapted to operatively associate with at least a portion of a cab of a vehicle.

In some embodiments, the hydraulic mount includes: one or more mounting bolts extending downwardly from a flange of the outer housing, the flange extending substantially normally to the central axis of the outer housing, the one or more mounting bolts adapted to secure the outer housing to the frame of the vehicle; a second washer associated with a second end of the tubular insert; and a bolt inserted through the tubular insert and contacting the second washer to operatively connect the at least a portion of the cab of the vehicle to the at least a portion of the frame of the vehicle.

In other embodiments, the fluid includes a non-compressible fluid.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings with like reference characters. It will be further understood that several of the FIGS. are merely schematic representations of the mount. As such, some of the components may have been distorted from their actual scale for pictorial clarity.

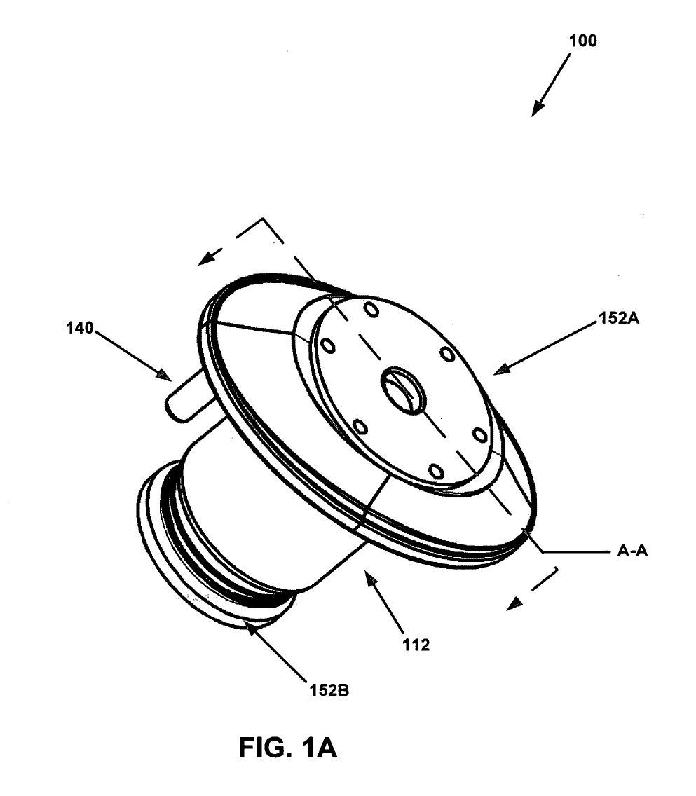

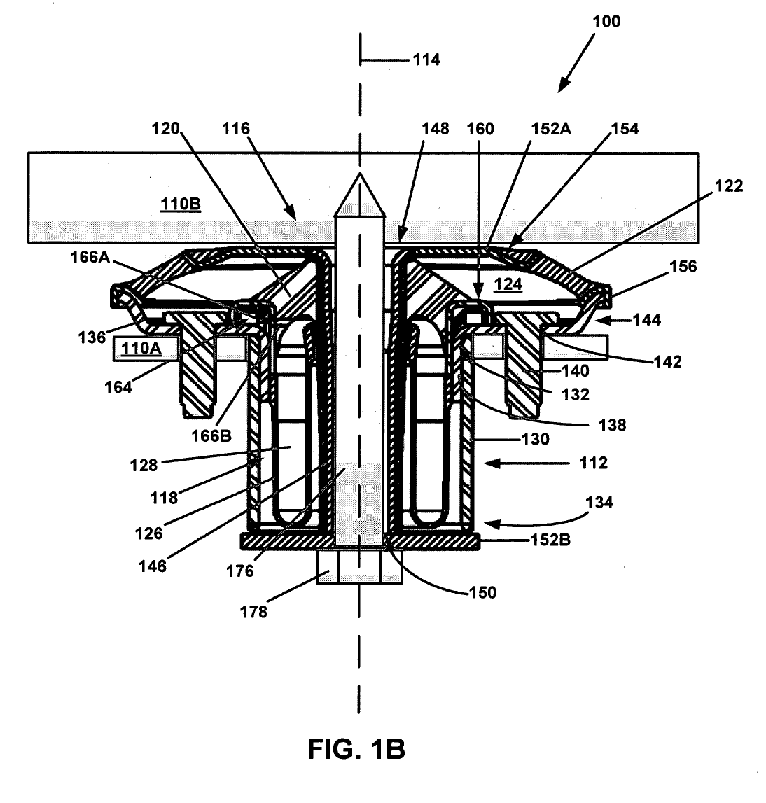

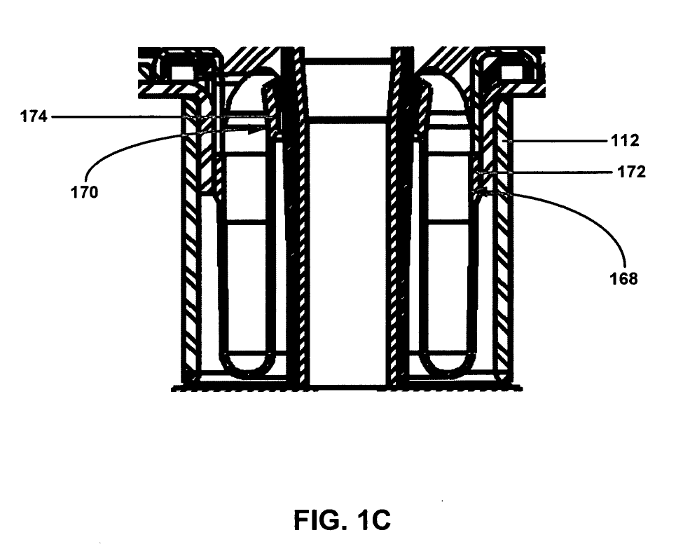

Referring now to the drawings, and more particularly to FIGS. 1A and 1B collectively, hydraulic mount 100, hereinafter sometimes referred to as mount 100, is shown therein. Typically, a plurality of mounts 100 are utilized for damping vibrational forces generated between frame 110A of a vehicle and cab 110B of a vehicle, although one of ordinary skill in the art with the present disclosure before them will appreciate that mount 100 may be utilized for any one of a number of vibrational damping applications.

Typical vibrational damping provided by mount 100 may affect first order vibrations between frame 110A of the vehicle and cab 110B of the vehicle. Moreover, the vibrational damping provided by mount 100 may be achieved due to the resonance of a fluid utilized within mount 100, as will be discussed in greater detail infra. Mount 100 may also be described as a fluid filled damping device that is capable of exhibiting a desired vibration-damping effect on the basis of bidirectional fluid communication through chambers formed in mount 100.

Mount 100 generally comprises outer housing 112 defining central axis 114 extending therethrough, tubular insert 116 disposed at least partially within outer housing 112 and in substantial axial alignment with central axis 114 so as to form annular cavity 118 therebetween. Mount 100 may also include inner elastomeric spring 120 and outer elastomeric spring 122 being spaced apart from one another to define first chamber 124.

Additionally, mount 100 preferably comprises diaphragm 126 disposed within annular cavity 118 and forming second chamber 128 that is in bilateral fluid communication with first chamber 124. It will be understood that uni-axial or multi-axial displacement of at least one of tubular insert 116 and outer housing 112 relative to one another causes fluid to communicate between first and second chambers 124 and 128, respectively.

Outer housing 112 may include cylindrical cup portion 130 having first open end 132 and second open end 134. Outer housing 112 may also include medial flange 136 that extends normally to central axis 114. Medial flange 136 may include rim 138 that is adapted to compressively fit within first open end 132 of cylindrical cup portion 130 to secure medial flange 136 to cylindrical cup portion 130. Medial flange 136 may include one or more bolts 140 (e.g., threaded studs) that extend downwardly through flat portion 142 for securing medial flange 136 to the frame of the vehicle (not shown). Additionally, medial flange 136 may include upwardly flared edge 144.

It will be understood that outer housing 112 may be constructed from any one of a number of different types of materials such as a metal, an alloy, a polymer, a resin, a natural product such as rubber, a composite, or any combination thereof. According to some embodiments, outer housing 112 may be fabricated from a material commonly utilized in the automotive industry such as aluminum or aluminum alloys. Outer housing 112 may also include an elastomeric coating that covers at least a portion of the outer surface of outer housing 112.

Tubular insert 116 preferably comprises body 146 having first and second ends 148 and 150, respectively. Tubular insert 116 preferably comprises upper flange 152A associated with first end 148 that extends generally normally to central axis 114 of outer housing 112. Upper flange 152A may include arcuate edge 154 that extends around the peripheral end of upper flange 152A and is angled to cooperate with outer elastomeric spring 122, as will be discussed in greater detail infra.

It will be understood that upper flange 152A may optionally include a washer that is adapted to associate with first end 148 of tubular insert 116. Additionally, tubular insert 116 may include lower flange 152B associated with second end 150.

It will be understood that tubular insert 116 may be constructed from any one of a number of different types of materials such as a metal, an alloy, a polymer, a resin, a natural product such as rubber, a composite, or any combination thereof. According to some embodiments, tubular insert 116 may be fabricated from a material commonly utilized in the automotive industry such as aluminum or aluminum alloys. Tubular insert 116 may also include an elastomeric coating that covers at least a portion of the outer surface of tubular insert 116.

Outer elastomeric spring 122 may extend between upwardly flared edge 144 of medial flange 136 of outer housing 112 and arcuate edge 154 of upper flange 152A of tubular insert 116. According to some embodiments, mount 100 may include outer spring support 156 disposed between upwardly flared edge 144 of outer housing 112 and outer elastomeric spring 122. Outer spring support 156 may be crimped or otherwise secured to upwardly flared edge 144 of outer housing 112.

Inner elastomeric spring 120 may extend between the outer surface of tubular insert 116 and inner spring support 160 disposed between outer housing 112 and tubular insert 116. Inner spring support 160 may extend from flat portion 142 of medial flange 136 of outer housing 112 and along the inner surface of rim 138, formed at least partially to surround path 164 that provides bidirectional communication of fluid between first and second chambers 124 and 128, respectively.

It will be understood that path 164 may be co-molded into inner elastomeric spring 120 and include first port 166A disposed along inner elastomeric spring 120 and second port 166B disposed below inner elastomeric spring 120.

First chamber 124 is formed between inner elastomeric spring 120 and outer elastomeric spring 122 and medial flange 136 of outer housing 112 and upper flange 152A of tubular insert 116.

As is best shown in FIG. 1C, second chamber 128 is formed by diaphragm 126, which in some embodiments includes a substantially U-shaped channel of flexible elastomeric material having first end 168 and second end 170. First end 168 may be attached to outer housing 112 via outer support ring 172. Second end 170 may be attached to the inner surface of tubular insert 116 via inner support ring 174. Because first and second ends 168 and 170 of diaphragm 126 are connected to outer housing 112 and tubular insert 116 independently from one another, when tubular insert 116 and outer housing 112 displace relative to one another, at least one of first end 168 and second end 170 displace causing diaphragm 126 to displace or “roll.”

Moreover, during displacement of either first end 168 or second end 170, mount 100 may act similarly to a shock absorber in that fluid may displace between first chamber 124 and second chamber 128 in a bidirectional manner as to provide suitable vibrational damping between the frame of the vehicle and the cab of the vehicle. For example, if the cab compresses mount 100, tubular insert 116 transfers compressive forces to inner elastomeric spring 120 and across upper flange 152A, down into outer elastomeric spring 122 and through to medial flange 136 causing first chamber 124 to compress. The compression of first chamber 124 causes fluid in first chamber 124 through path 164 and into second chamber 128. Additionally, first end 168 of diaphragm 126 connected to tubular insert 116 displaces downwardly relative to second end 170 of diaphragm 126.

It will be understood that the size and shape of first and second chambers 124 and 128 may vary according to design requirements (e.g., desired vibration damping).

In operation, one or more mounts 100 may be secured to frame 110A of the vehicle via one or more bolts 140 that extend at least partially through apertures fabricated into frame 110A. Hexagonal nuts (not shown) may be threaded onto portions of one or more bolts 140 extend through frame 110A. Mount 100 may be secured to cab 110B via bolt 176 that extends through tubular insert 116 and into cab 110B (e.g., a lower frame plate of the cab). Head 178 of bolt 176 contacts lower flange 152B of tubular insert 116 urging mount 100 upwardly towards cab 1108.

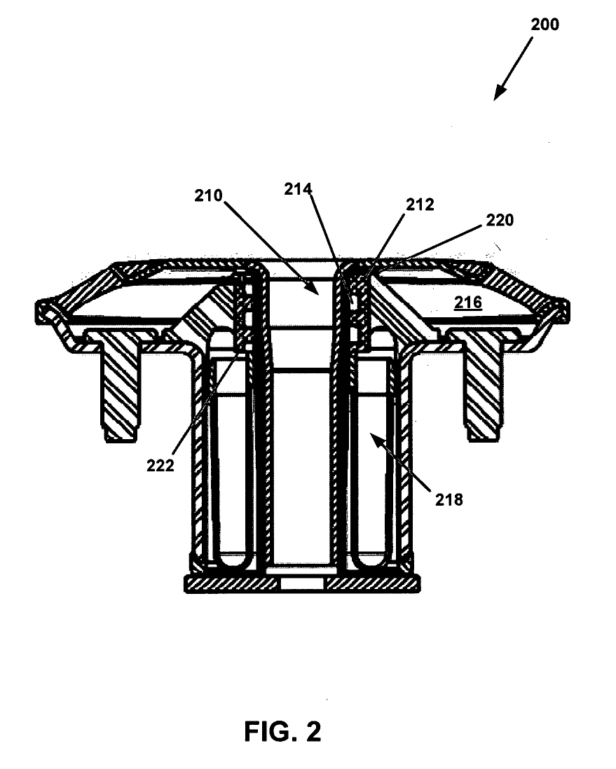

Referring now to FIG. 2, an alternative embodiment of a hydraulic mount, hereinafter referred to as mount 200 is shown. It will be understood that mount 200 may be constructed similarly to mount 100 of FIGS. 1A-1C, with the exception that tubular insert 210 of mount 200 includes casing 212 that surrounds at least a portion of tubular insert 210. Casing 212 may include helical path 214 for bilateral communication of fluid between first and second chambers 216 and 218, respectively.

It will be understood that helical path 214 may include first port 220 disposed above body 222 of inner elastomeric spring 224 and second port 226 may be disposed below body 222 of inner elastomeric spring 224.

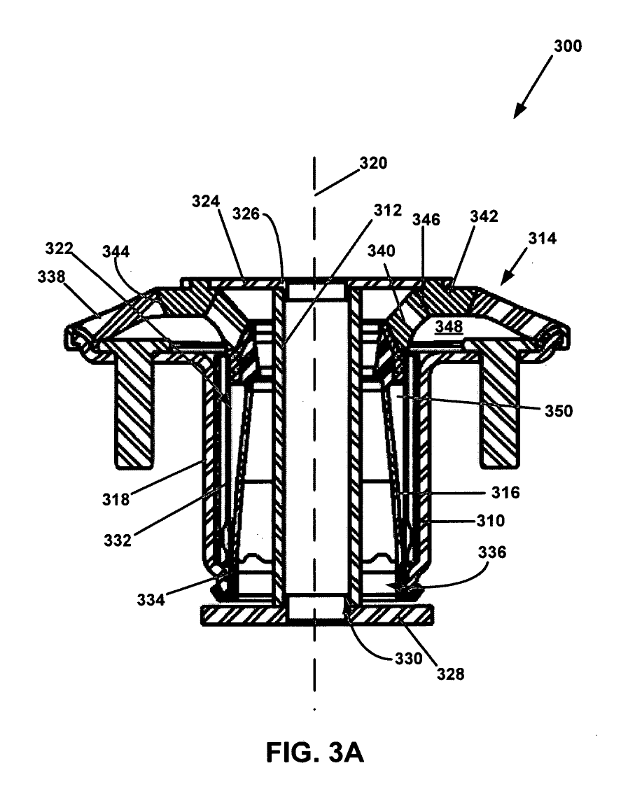

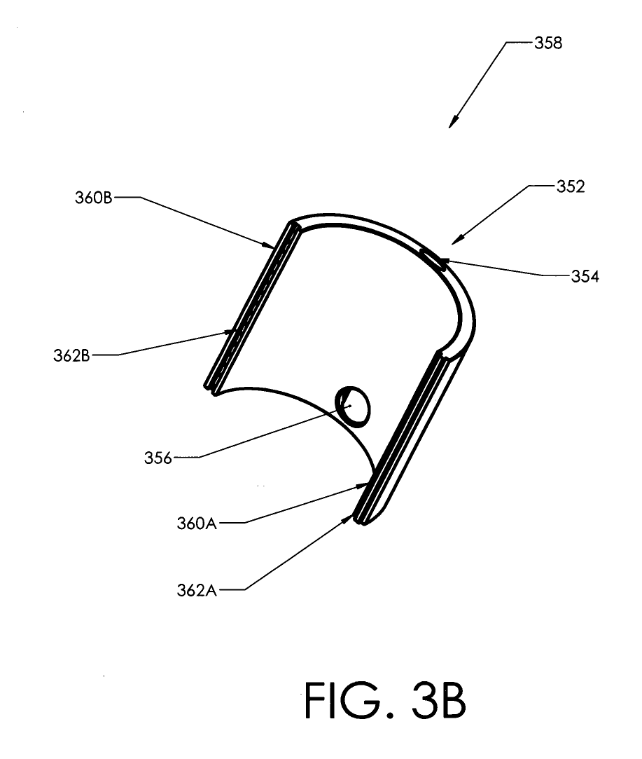

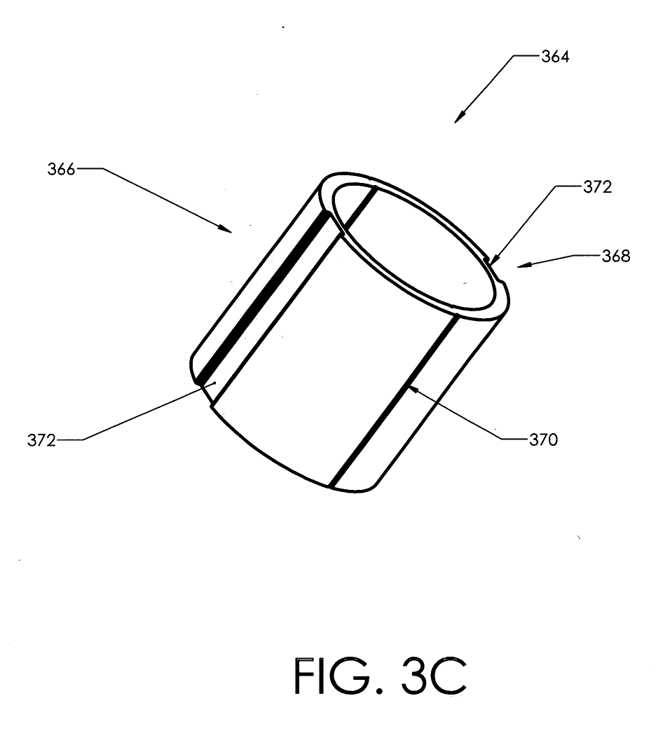

Referring now to FIGS. 3A-3C, an additional alternative embodiment of a hydraulic mount, hereinafter referred to as mount 300 is shown. Mount 300 generally comprises outer housing 310, tubular insert 312, elastomeric core 314, and diaphragm 316.

Outer housing 310 includes cylindrical tubular portion 318 defining central axis 320 extending therethrough. Tubular insert 312 may be disposed at least partially within outer housing 310 and in substantial axial alignment with central axis 320 so as to form annular cavity 322 therebetween. Tubular insert 312 may include first washer 324 associated with first end 326 and second washer 328 associated with second end 330 of tubular insert 312.

Mount 300 may also include tubular body 332 disposed within annular cavity 322 such that an outer surface of tubular body 332 contacts an inner surface of outer housing 310. Tubular body 332 may rest upon support member 334 that is also utilized to associate a terminal end of diaphragm 316 with first end 336 of outer housing 310.

Elastomeric core 314 extends between first washer 324 of tubular insert 312 and outer housing 310. Additionally, elastomeric core 314 may be divided into outer portion 338 and inner portion 340 by connector 342 that extends downwardly from first washer 324. Connector 342 includes first angled surface 344 that contacts outer portion 338 and second angled surface 346 that contacts inner portion 340.

Elastomeric core 314 cooperates with outer housing 310 to form first chamber 348. Diaphragm 316 may extend downwardly and flare outwardly from central axis 320 to contact first end 336 of outer housing 310, forming second chamber 350. Additionally, diaphragm 316 may be secured to first end 336 of outer housing 310 via support member 334.

Referring now to FIGS. 3A and 3B collectively, tubular body 332 extends between first chamber 348 and second chamber 350 and includes two paths 352 for bidirectional communication of fluid therebetween. Paths 352 may each include first port 354 associated with first chamber 348 and second port 356 associated with second chamber 350. FIG. 3B shows only first portion 358 of tubular body 332 that may be joined together with a second portion (not shown) via joints 360A and 360B, which in this embodiment includes male (362A) and female (362B) dovetail sections.

It will be understood that one particular advantage mount 300 includes the ability to mold both elastomeric core 314 and diaphragm 316 in a singular molding process, thereby reducing manufacturing costs associated with fabricating mount 300.

Referring now to FIG. 3C, an alternative tubular body 364 is shown. Tubular body 364 may be fabricated from a single piece of polymeric material. The singular piece may then split into two sections 366 and 368 along fine notch lines 370 that extend along the length of tubular body 364 by lowering the temperature of tubular body 364 below the “glass transition temperature.” Below this temperature, the material is very brittle and allows tubular body 364 to be split along fine notch lines 370 into sections 366 and 368 that mate to each other. It will be understood that the fractured surfaces of sections 366 and 368 match each other so that there is negligible internal leakage from inside diameter to outside diameter.

Tubular body 364 may include fluid channels 372 that cooperate with the inner surface of outer housing 310 to form paths for bidirectional communication of fluid between first and second chambers 348 and 350, respectively.

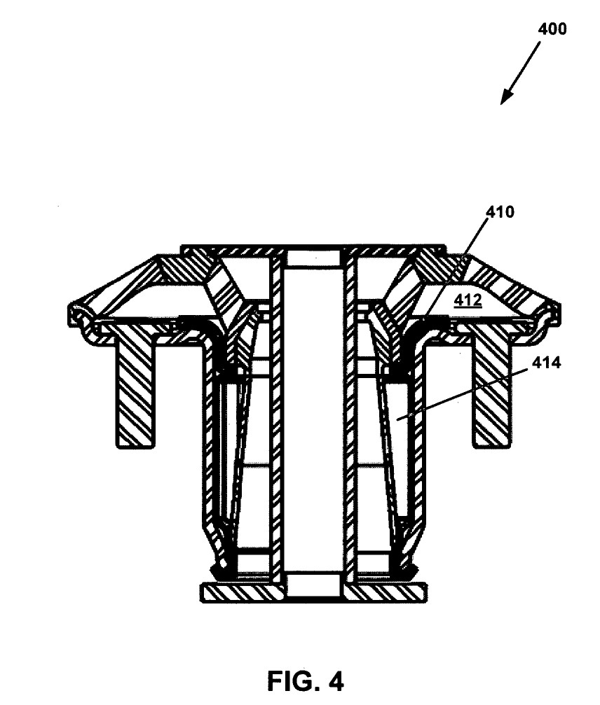

FIG. 4 illustrates yet another embodiment of a hydraulic mount, hereinafter referred to as mount 400. Mount 400 is constructed similarly to mount 300 (see FIG. 3A) with the exception that rather than having a tubular body, mount 400 is provided with tubular spacer 410. A notch in tubular spacer 410 provides bilateral communication of fluid between first chamber 412 and second chamber 414.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A hydraulic mount, comprising:
an outer housing having a central axis extending therethrough;
a tubular insert disposed at least partially within the outer housing and in substantial axial alignment with the central axis so as to form an annular cavity therebetween, the tubular insert having a flange extending from a first end of the tubular insert;
an inner elastomeric spring and an outer elastomeric spring extending between the flange of the tubular insert and the outer housing, the inner and the outer elastomeric springs being spaced apart from one another to define a first chamber;
a diaphragm disposed within the annular cavity and forming a second chamber that is in bilateral fluid communication with the first chamber, the diaphragm having a first end attached to at least a portion of the outer housing and a second end attached to at least a portion of the tubular insert; and
wherein displacement of at least one of the tubular insert and the outer housing relative to one another causes fluid to communicate between the first and second chambers and at least one of the first end and the second end of the diaphragm to displace relative to one another.

2. The hydraulic mount according to claim 1, wherein the outer housing is adapted to operatively associate with at least a portion of a frame of a vehicle and the tubular insert is adapted to operatively associate with at least a portion of a cab of a vehicle.

3. The hydraulic mount according to claim 2, further including:
one or more mounting bolts extending downwardly from a flange of the outer housing, the flange extending substantially normally to the central axis of the outer housing, the one or more mounting bolts adapted to secure the outer housing to the frame of the vehicle; and
a washer associated with a second end of the tubular insert and a bolt inserted through the tubular insert for operatively connecting the at least a portion of the cab of the vehicle to the at least a portion of the frame of the vehicle.

4. The hydraulic mount according to claim 1, wherein the fluid includes a non-compressible fluid.

5. The hydraulic mount according to claim 1, further comprising a path for bilateral communication of fluid between the first chamber and the second chamber, the path extending at least partially through the inner elastomeric spring.

6. The hydraulic mount according to claim 1, further comprising a helical path for the bilateral communication of fluid between the first and second chambers, the helical path extending through a casing that surrounds at least a portion of the tubular insert.

7. The hydraulic mount according to claim 6, wherein a first port of the helical path is disposed above a body of the inner elastomeric spring and a second port of the helical path is disposed below the body of the inner elastomeric spring.

8. A hydraulic mount, comprising:
an outer housing having a central axis extending therethrough;
a tubular insert disposed at least partially within the outer housing and in substantial axial alignment with the central axis so as to form an annular cavity therebetween, the tubular insert having a first washer extending from a first end of the tubular insert;
a tubular body disposed within the annular cavity, the tubular body having at least one path for the bilateral communication of fluid;
an elastomeric core disposed between the first washer of the tubular insert and the outer housing, the elastomeric core cooperating with the outer housing and the first washer of the tubular insert to form a first chamber;
a diaphragm associated with the tubular body and the outer housing, the diaphragm cooperating with the tubular body to form a second chamber; and
wherein displacement of at least one of the tubular insert and the outer housing relative to one another causes fluid to communicate between the first and second chambers via the at least one path of the tubular body.

9. The hydraulic mount according to claim 8, wherein the elastomeric core includes an outer portion and an inner portion spaced apart from one another by a connector that extends downwardly from the first washer of the tubular insert.

10. The hydraulic mount according to claim 9, wherein the connector includes an outer surface associated with the outer portion of the elastomeric core and an inner surface associated with the inner portion of the elastomeric core.

11. The hydraulic mount according to claim 8, wherein the diaphragm is associated with the tubular body via a support member which is also associated with the inner portion of the elastomeric core.

12. The hydraulic mount according to claim 11, wherein the diaphragm flares outwardly from the support member to contact a first end of the outer housing.

13. The hydraulic mount according to claim 8, wherein the tubular body includes a first port associated with the first chamber and a second port associated with the second chamber.

14. The hydraulic mount according to claim 8, wherein the tubular body includes a first section and a second section adapted to fit together.

15. The hydraulic mount according to claim 8, wherein the tubular body includes at least one channel extending along the outer surface of the tubular body substantially parallel to the central axis of the outer housing.

16. The hydraulic mount according to claim 15, wherein the at least one channel of the tubular body cooperates with an inner surface of the outer housing to form the at least one path for the bilateral communication of fluid.

17. The hydraulic mount according to claim 8, wherein the outer housing is adapted to operatively associate with at least a portion of a frame of a vehicle and the tubular insert is adapted to operatively associate with at least a portion of a cab of a vehicle.

18. The hydraulic mount according to claim 17, further including:
one or more mounting bolts extending downwardly from a flange of the outer housing, the flange extending substantially normally to the central axis of the outer housing, the one or more mounting bolts adapted to secure the outer housing to the frame of the vehicle;
a second washer associated with a second end of the tubular insert; and
a bolt inserted through the tubular insert and contacting the second washer to operatively connect the at least a portion of the cab of the vehicle to the at least a portion of the frame of the vehicle.

19. The hydraulic according to claim 8, wherein the fluid includes a non-compressible fluid.
